(19) United States
(12) Patent Application Publication
(10) Pub. No.: US 2008/0155214 A1
(43) Pub. Date: Jun. 26, 2008

(54) Method and apparatus for file system virtualization

(76) Inventor: Hidehisa Shitomi, Mountain View, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/642,525

(22) Filed: Dec. 21, 2006

(51) Int. Cl. G06F 12/16; G06F 17/30

(52) U.S. Cl. 711/162; 707/10; 707/E17.032; 711/E12.103

(57) ABSTRACT

File system virtualization and migration in a Global Name Space on network attached storage (NAS) system, includes file system virtualization by managing file attributes on a NAS virtualization system. The NAS virtualization system receives a file access operation sent from a client computer directed to one of the underlying NAS systems. The NAS virtualization system locates a file identifier included in the file access operation. The file identifier includes node information identifying a second NAS as a destination of the file access operation. The NAS virtualization system removes the node information from the file identifier and forwards the file access operation to the second NAS identified by the node information. The NAS virtualization system receives a reply from the second NAS, adds the node information back to the file identifier included with the response, and forwards the response to the computer with file identifier and appended node information.

### BACKGROUND OF THE INVENTION

1. Field of the Invention

The present invention relates generally to storage systems, such as Network Attached Storage (NAS) systems.

2. Description of Related Art

A Global Name Space (GNS) is a functionality that integrates multiple file systems provided by separate NAS systems into a single “global” name space, and provides the integrated name space to NAS clients. A GNS allows clients to access files without knowing their actual location. A GNS also enables system administrators to aggregate file storage spread across diverse or physically distributed storage devices, and to view and manage file storage as a single file system. By utilizing a GNS, system administrators can migrate a file system from one NAS node to another NAS node without causing client disruptions, and clients are automatically redirected to the files in their new location without ever having to know about the migration or having to change file system mount points. Such data migration in file systems often occurs for purposes of capacity management, load balancing, NAS replacement, and/or data life cycle management. Thus, a GNS hides the complexities of the storage architecture from the users and enables the system administrators to manage the physical layer without affecting how users access files.

In the prior art, the GNS has been implemented in the local file system layer. Under this method, the local file systems over multiple NAS nodes can exchange and store the file system location information. Then, even if a NAS client accesses a NAS node that does not have a designated file system, the NAS node can forward the request to an appropriate NAS node. However, this prior art method does not allow creation of a GNS from heterogeneous NAS systems because all file systems in this form of GNS must be identical.

Other prior arts include a file service appliance that provides a GNS. The appliance forwards NFS (Network File System) operations to underlying NAS systems. Since the appliance just switches the operations to an appropriate NAS system based on the file system location information in the appliance, the appliance can create a GNS from heterogeneous NAS systems. However, the appliance is only able to provide a GNS, and is not able to virtualize other functionalities in the underlying NAS systems that would increase the usefulness and efficiency of the overall system. Further, the prior art appliance itself is not a NAS system able to store its own local file system and file data.

Thus, the prior art fails to teach any method or apparatus for providing true file system virtualization in NAS systems. For example, while a GNS provides a convenient method for file system management and for facilitating file system migration in NAS systems, a GNS alone is not able to virtualize file system functionalities of underlying NAS systems for providing additional advantages.

### BRIEF SUMMARY OF THE INVENTION

The invention discloses methods and apparatuses for virtualizing file systems. In embodiments of the invention, a first NAS node is able to virtualize other NAS systems and provide capabilities such as file level migration, user account management, and quota management over the virtualized NAS systems. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware configuration in which the method and apparatus of the invention may be applied.

FIG. 2 illustrates an example of a software configuration in which the method and apparatus of the invention may be applied.

FIG. 3 illustrates a conceptual diagram of the GNS functionality of the invention.

FIG. 4 illustrates a typical procedure to generate a file handle according to the invention.

FIG. 5 illustrates a typical procedure to access a file such as during a read or write request.

FIG. 6 illustrates a conceptual diagram of the file level migration mechanism.

FIG. 7 illustrates a control flow of the file migration.

FIG. 8 illustrates a control flow of file access to the migrated file.

FIG. 9 illustrates a control flow when file migration occurs before a NFS client accesses the file and the NFS client does not have the file handle.

FIG. 10 illustrates a conceptual diagram of attribute management in the NAS virtualization system.

FIG. 11 illustrates a control flow of attribute access to a file having attributes managed in the NAS virtualization system.

FIG. 12 illustrates a conceptual diagram of integrated account management and access control in the NAS virtualization system of the invention.

FIG. 13 illustrates a control flow of an integrated account management table creation phase.

FIG. 14 illustrates a control flow in which file access is controlled by the NAS virtualization system.

FIG. 15 illustrates a conceptual diagram of quota management in the NAS virtualization system.

FIG. 16 illustrates a control flow of quota setting in the NAS virtualization system.

FIG. 17 illustrates a control flow of file access during quota management at the NAS virtualization system.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any manner.

As discussed above, a GNS provides a convenient method for file system management and file system migration, but a GNS alone is not able to virtualize underlying file system functionalities. The invention discloses methods and apparatuses for virtualizing file systems, and also enables the creation of a GNS. In some embodiments, a first NAS node maintains file attributes of files that exist on other NAS nodes in the system to enable virtualization of the other NAS nodes by the first NAS node. The first NAS system provides capabilities such as file-level migration, user account management, and quota management over the virtualized NAS nodes. Thus, embodiments of the invention are able to provide innocuous file level migration and virtualize underlying file system functionalities.

The NAS virtualization system of the invention is able to provide a GNS, preferably implemented in the NFS layer. In addition to enabling a GNS, the NAS virtualization system of the invention provides for file level migration, which means the path name management of files resides in the underlying NAS systems. Moreover, the NAS virtualization system of the invention is able to virtualize a number of functionalities, such as user account management, user access control, and quota management by managing file attributes at the virtualization layer.

### First Embodiments

### System Configurations

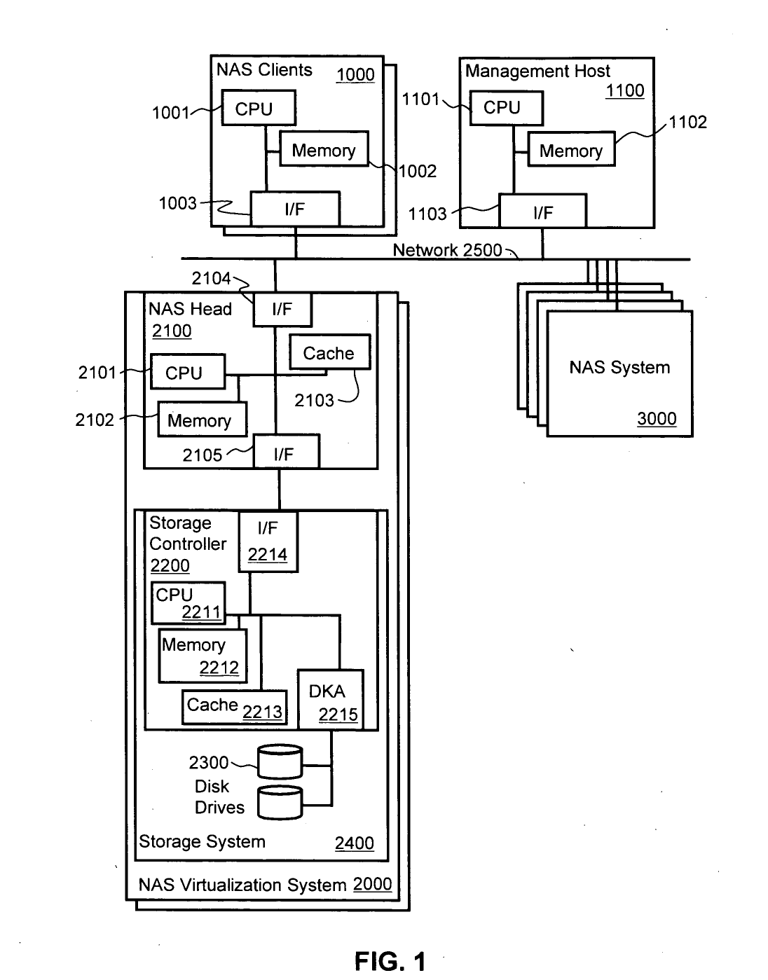

FIG. 1 illustrates an example of a hardware configuration of an information system in which the method and apparatus of the invention may be applied. The system is composed of one or more NAS clients 1000, a management host 1100, one or more NAS virtualization systems 2000, and one or more NAS systems 3000 able to communicate via a network 2500.

Each NAS client 1000 may include a memory 1002 for storing application and NFS client software (not shown in FIG. 1), and a CPU 1001 for executing the software loaded in memory 1002. NAS client 1000 also includes an interface (I/F) 1003 t6 enable connection of NAS client 1000 to network 2500. The typical media of network 2500 may be Ethernet (e.g., arranged in a LAN), and I/F 1003 may be a network interface card (NIC) or the like, but other network protocols may also be used.

Management host 1100 includes a memory 1102 storing a management software (not shown in FIG. 1), and includes a CPU 1001 for executing the software loaded in memory 1102. Management host 1100 includes an I/F 1103 for enabling communication with the NAS systems 2000, 3000 via network 2500. I/F 1103 may be a NIC or other suitable interface device.

NAS virtualization system 2000 consists mainly of two parts: a NAS head 2100, and a storage system 2400. Further, storage system 2400 consists of a storage controller 2200 and one or more storage devices 2300, such as hard disk drives. NAS head 2100 and storage system 2400 are able to be connected for communication via a back-end I/F 2105 and a host I/F 2214, respectively. NAS head 2100 and storage system 2400 may exist in one storage unit, called a “filer”. In this case, these two elements are connected via a system bus such as a PCI bus. On the other hand, NAS head 2100 and controller 2200 may be physically separated. In this case, the two elements are connected via a network connection such as Fibre Channel (FC) or Ethernet. Also, while there are various hardware implementations possible, any of the implementations can be applied to the invention. Further, multiple NAS virtualization systems 2000 may be provided in the information system to provide failover redundancy, load balancing or other purposes.

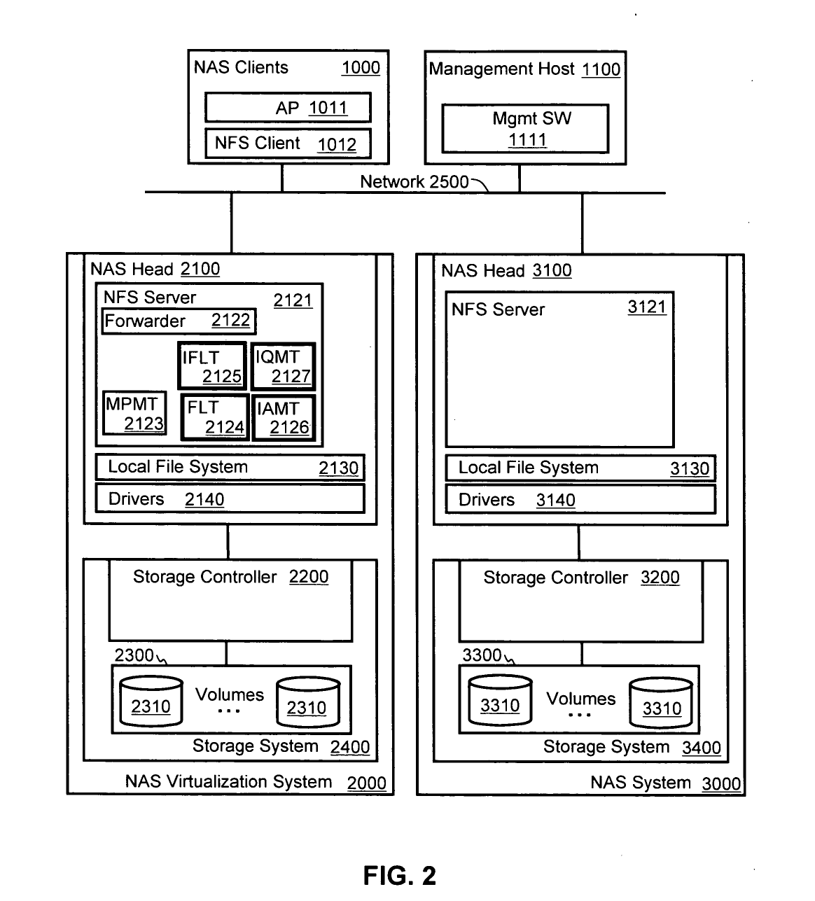

NAS head 2100 includes a CPU 2101, a memory 2102, a cache 2103, a front-end network I/F 2104 for communication with network 2500, and back-end I/F 2105 for enabling NAS head 2100 to communicate with storage system 2400. NAS head 2100 processes access requests and instructions received from NAS clients 1000 and management host 1100. A program (discussed below with respect to FIG. 2) to process NFS requests or other operations is stored in the memory 2002, and CPU 2001 executes the program. Cache 2103 temporarily stores NFS write data received from NFS clients 1012 before the data is forwarded to the storage system 2400, and cache 2103 stores NFS read data that is requested by the NFS clients 1012 as the read data is retrieved from storage system 2400. Cache 2103 may be a battery backed-up non-volatile memory. In another implementation, memory 2102 and cache memory 2103 are combined common memory.

Front-end I/F 2104 is used to connect both between NAS head 2100 and NAS clients 1000, and between NAS head 2100 and NAS systems 3000 via network 2500. Accordingly, Ethernet is a typical example of the protocol type. Back-end I/F 2105 is used to connect between NAS head 2100 and storage system 2400. Fibre Channel and Ethernet are typical examples of the type of connection. Alternatively, in the case of and internal connection between NAS head 2100 and controller 2200 (i.e., in the case of a single storage unit implementation), a system bus is a typical example of the connection type.

The storage controller 2200 includes a CPU 2211, a memory 2212, a cache memory 2213, host I/F 2214, and a disk I/F (DKA) 2215. Storage controller 2200 processes input/output (I/O) requests from NAS head 2100. A program (not shown) to process I/O requests or other operations is stored in the memory 2212, and CPU 2211 executes the program. Cache memory 2213 temporarily stores the write data received from NAS head 2100 before the data is stored into disk drives 2300, or cache memory 2213 stores read data requested by NAS head 2100 as the data is retrieved from disk drives 2300. Cache 2213 may be a battery backed-up non-volatile memory. In another implementation, memory 2212 and cache memory 2213 may be combined common memory. Host I/F 2214 is used to enable controller 2200 to communicate with NAS head 2100 via backend I/F. Fibre Channel and Ethernet are typical examples of the connection type. As discussed above, a system bus connection, such as PCI may also be applied. Disk I/F 2215 is used to connect disk drives 2300 for communication with storage controller 2200. Disk drives 2300 process the I/O requests in accordance with disk device commands, such as SCSI commands.

For NAS system 3000, the hardware configurations may be the same as described above for NAS virtualization system 2000, and accordingly, do not need to be described again. Also, as with NAS virtualization system 2000, although there are various hardware implementations possible, any of the implementations can be applied to the invention. The difference between NAS virtualization system 2000 and NAS systems 3000 is primarily due to the software modules and data structures present, and the functionality of NAS virtualization system 2000. Other appropriate hardware architecture can also be applied to the invention.

FIG. 2 illustrates an example of a software configuration in which the method and apparatus of this invention may be applied. As discussed above, each NAS client 1000 may be a computer on which some application (AP) 1011 generates file manipulating operations. A Network File System (NFS) client program 1012, such as NFSv2, v3, v4, or CIFS is also typically present on the NAS client node 1000. The NFS client program 1012 communicates with an NFS server program 2121 on NAS virtualization systems 2000 through network protocols such as TCP/IP (Transmission Control Protocol/Internet Protocol). The NFS clients 1012 and NAS virtualization system 2000 are able to communicate via network 2500. In other implementations, it is possible for the NAS clients 1000 to be directly connected for communication with the NAS systems 3000 via network 2500, but in such a case, the NAS clients cannot share the NAS virtualization merits provided by the invention.

Management host 1100 includes a management software 1111 that resides on management host 1100. NAS management operations such as system configuration settings can be issued from the management software 1111. Further, management software 1111 typically provides an interface to enable an administrator to manage the information system.

In NAS virtualization system 2000, NAS head 2100 serves as a virtualization providing means, and file-related operations are processed in NAS head 2100. NAS head 2100 includes a NFS server 2121, a local file system 2130 and drivers 2140. The local file system 2130 processes file I/O operations to the file systems on the storage system 2400. Drivers 2140 translate the file I/O operations to the block level operations, and communicate with storage controller 2200 via SCSI commands. NFS server 2121 enables communication with both NFS clients 1012 on the NAS clients 1000, and also to enables processing of NFS operations to the file systems on NAS virtualization system 2000. Further, operations directed to file systems located on NAS systems 3000 whose file systems are part of a Global Name Space (GNS) are able to be processed in NFS server 2121 on NAS virtualization system 2000, and more precisely, between the NFS server layer and the RPC (Remote Procedure Call) layer.

NFS server 2121 includes a plurality of modules and/or data structures stored in memory 2102 or other computer readable medium. These modules and data structures may be part of NFS server 2121, or may exist outside of NFS server 2121 and simply be called or implemented by NFS server 2121 when needed. The modules and data structures are utilized for carrying out virtualization and file-related operations, and include a forwarder module 2122, a mount point management table (MPMT) 2123, a file location table (FLT) 2124, an inode and file location table (IFLT) 2125, an integrated account management table (IAMT) 2126, and an integrated quota management table IQMT 2127. The forwarder module 2122 traps or intercepts the NFS operations sent from NFS client 1012 to the NAS systems 3000. When the forwarder module 2122 receives a NFS operation directed to one of NAS systems 3000, the forwarder module 2122 locates a file handle in the NFS operation, which includes bits representing a destination of the operation. Then, the forwarder module 2122 forwards the operation to the destination NAS system 3000 based upon the destination information in the file handle. The destination address for an operation can be managed by the mount point management table (MPMT) 2123. In addition to management of a GNS, file level migration can also be performed on this layer, and the file location table (FLT) 2124 can be utilized at the file level migration.

Moreover some NAS functionalities provided by the NAS systems 3000 can be processed in the NAS virtualization system 2000, which means the NAS virtualization system 2000 virtualizes functions of the NAS systems 3000. The inode and file location table (IFLT) 2125 can be utilized in this capacity. Account management and quota management are examples of such virtualized functionalities. Further, when NAS virtualization system 2000 virtualizes the account management of the NAS systems 3000, the integrated account management table (IAMT) 2126 can be employed. When the NAS virtualization system virtualizes the quota management of the NAS systems, the integrated quota management table (IQMT) 2127 can be employed. Other modules and/or data structures may be included for particular embodiments of the invention, as described below.

Storage controller 2200 on storage system 2400 processes SCSI commands received from NAS head 2100 for storing data in logical volumes 2310 which are allocated physical storage space on disk drives 2300. Thus, a volume 2310 is composed of storage capacity on one or more disk drives 2300, and file systems are able to be created in volumes 2310 for storing files.

Similar to NAS virtualization system 2000, each NAS System 3000 may consist of two main parts: a NAS head 3100 and a storage system 3400. NAS head 3100 carries out file-related operations, and includes a NFS server 3121, a local file system 3130 and drivers 3140. The local file system 3130 processes file I/O operations to the storage system 3400. Drivers 3140 translate file I/O operations to block level operations, and communicate with storage controller 3200 via SCSI commands. NFS server 3121 enables NAS system 3000 to communicate with NAS virtualization system 2000. In alternative embodiments, the NFS server 3121 can also be able to communicate directly with NFS clients 1012 on the NAS clients 1000, but in such a case, the NFS operations are sent to file systems which are not a part of the GNS.

Storage system 3400 includes a storage controller 3200 that processes SCSI commands received from NAS head 3100, for storing data in logical volumes 3310 that are allocated physical storage space on disk drives 3300. A volume 3310 is allocated storage capacity on one or more disk drives 3300, and file systems are created in volumes 3310 for storing files.

Global Name Space (GNS)

The Global Name Space (GNS) is a functionality that integrates multiple separate file systems provided by multiple separate NAS systems into a single integrated name space, and provides the integrated name space for the use of the NAS clients. By utilizing GNS, system administrators can migrate a file system or a portion thereof from a NAS node to another NAS node without client disruptions, which means that clients do not need to know about the migration and do not have to change the mount point to access a migrated file or directory. Such migration might occur due to capacity management, load balancing, NAS replacement, and/or data life cycle management.

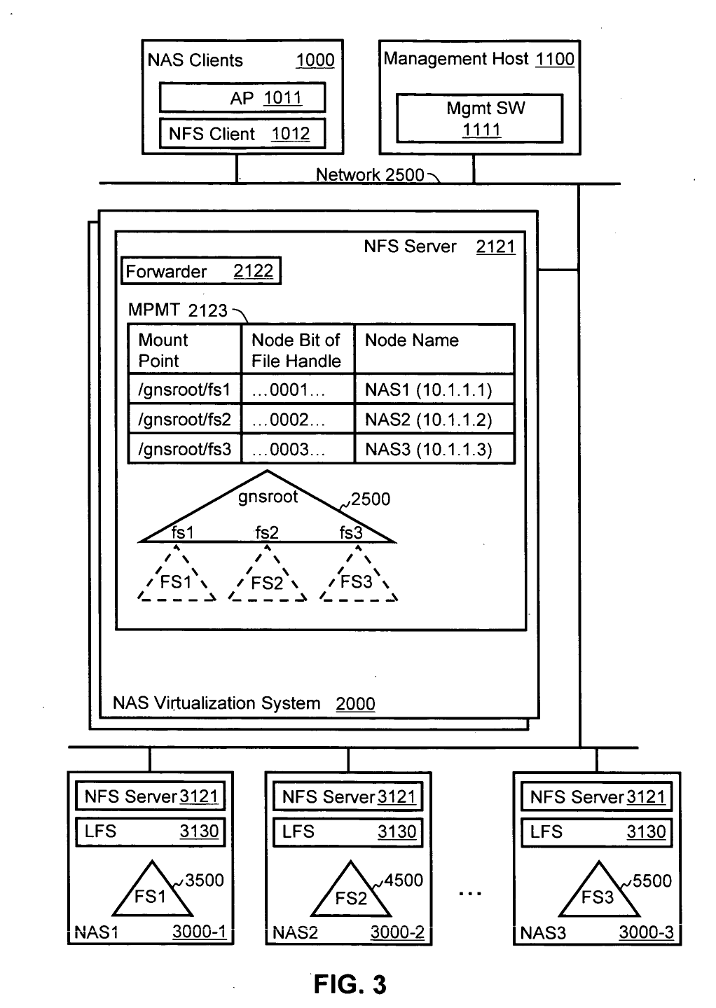

The NAS virtualization system 2000 of the invention is able to provide GNS functionality. The GNS of the invention may be implemented in the NFS layer. FIG. 3 represents a conceptual diagram of the GNS functionality of the invention. The NAS virtualization system 2000 creates a GNS 2500 from a file system one (FS1) 3500 on NAS1 3000-1, a file system two (FS2) 4500 on NAS2 3000-2, and a file system three (FS3) 5500 on NAS3 3000-3. In GNS 2500, FS1 3500 mounts on “/gnsroot/fs1”, FS2 4500 mounts on “/gnsroot/fs2”, and FS3 5500 mounts on “/gnsroot/fs3”. In the example, the file systems construct a GNS on NAS virtualization system 2000 composed of files systems that exist on separate underlying NAS systems 3000-1, 3000-2 and 3000-3. However, this is not a restriction of the invention, which means that file systems located on NAS virtualization system 2000 can also participate in the GNS, because the NAS virtualization system 2000 is also a NAS system itself, which provides an advantage over the prior art.

Mount Point Management Table (MPMT) Creation Phase

At first, a system administrator creates a GNS on NAS virtualization system 2000 that includes a file system mapping table, such as mount point management table (MPMT) 2123, through use of management software 1111 on management host 1100. MPMT 2123 maintains the association of mount points in the GNS with file systems on NAS systems. As illustrated in FIG. 3, the typical entries for a file system mapping table are mount point, node bit information in a file handle, and node name for obtaining the file system.

Typically, an NFS file handle is a unique file identifier, such as a number, having a prescribed bit length (e.g., 32 bits) that is assigned to a file by the NAS system that stores the file. The file handle is a shorthand reference used internally by the NAS system to access the file, instead of having to use the full path of the file for each access.

According to the invention, the NAS virtualization system 2000 appends a node bit information to a file handle to aid in identifying a file's location in the information system. The node bit information added to the file handle represents the file system location in the information system (i.e., the virtualization system 2000 creates a number that represents the NAS node at which each file system making up the GNS is actually stored). Thus, the node bit information when attached or appended to a file handle provides additional information in the file handle that indicates at which node the file system is located that contains the file identified by the file handle.

In operation, the forwarder module 2122 traps the NFS operations from the clients, reads the node bit information, and forwards the NFS operation to an appropriate NAS system 3000 as indicated by the node bit. If the node bit information indicates that the file is located in the NAS virtualization system 2000 itself, then the NFS operation does not need to be forwarded, and is instead processed locally. As mentioned above, the operations carried out by the forwarder module 2122 may be implemented between the NFS server layer and the RPC layer. Further, at the time that the MPMT 2123 is created, the node bit patterns to all NAS nodes are decided and stored in the MPMT as the node bit information to be used for file handles.

File Access Phase

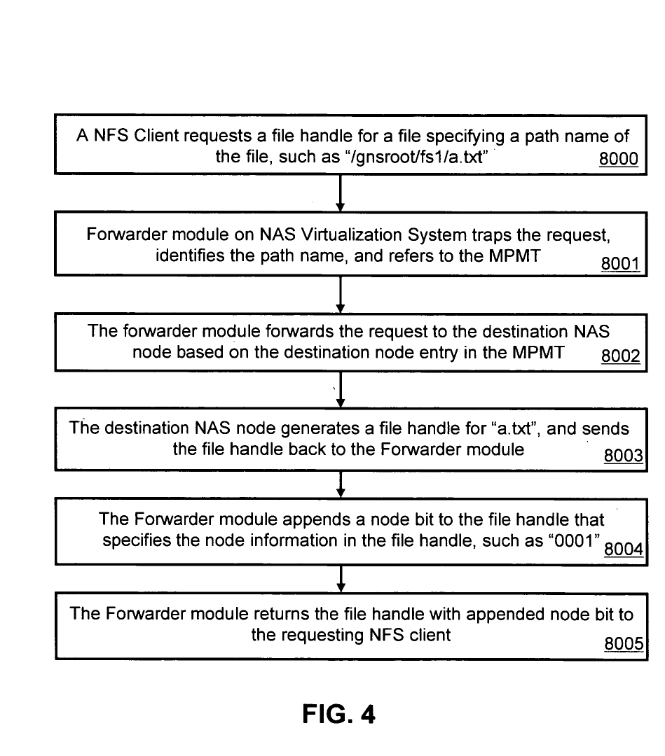

Typically, before being able to access a file, a NFS client 1012 needs to obtain a file handle for the file. FIG. 4 illustrates a typical procedure to generate a file handle according to the invention, with a description of the steps carried out being set forth below.

Step 8000: A NFS client 1012 requests a file handle for a file by specifying a path name of the file such as “/gnsroot/fs1/a.txt”. Thus, the NFS client 1012 wants to obtain the file handle for a file that is named “a.txt” and that is stored in FS1 3500 on NAS1 3000-1.

Step 8001: Forwarder module 2122 on a NAS virtualization system 2000 traps the request, identifies the part of path name (“/gnsroot/fs1”) in the request, and looks up the MPMT 2123 to determine the targeted destination NAS node.

Step 8002: Forwarder module 2122 forwards the request to the destination NAS node based upon the destination node entry in the MPMT 2123. In the example given, the path name identifies FS1, so the forwarder module 2122 forwards the request to NAS1 3000-1 to obtain the file handle from NAS1 3000-1.

Step 8003: NAS1 generates a file handle for the file “a.txt”, and sends the generated file handle back to the forwarder module 2122 in NAS virtualization system 2000.

Step 8004: Prior to sending the file handle to the requesting NFS client, the forwarder module 2122 appends a node bit information to the file handle, which specifies the node information directly in the file handle such as “0001”. The length of the node bit should be a long enough number to individually specify all NAS nodes used in creating the GNS. As mentioned above, the node bit for each NAS node can be determined at the MPMT creation. Alternatively, the node bit information can be determined at this point, when it is first needed, and the node bit can be stored in the MPMT 2123 at this point.

Step 8005: The forwarder module 2122 returns the file handle to the requesting NFS client 1012, and the NFS client is then able to use the file handle when requesting access to the file.

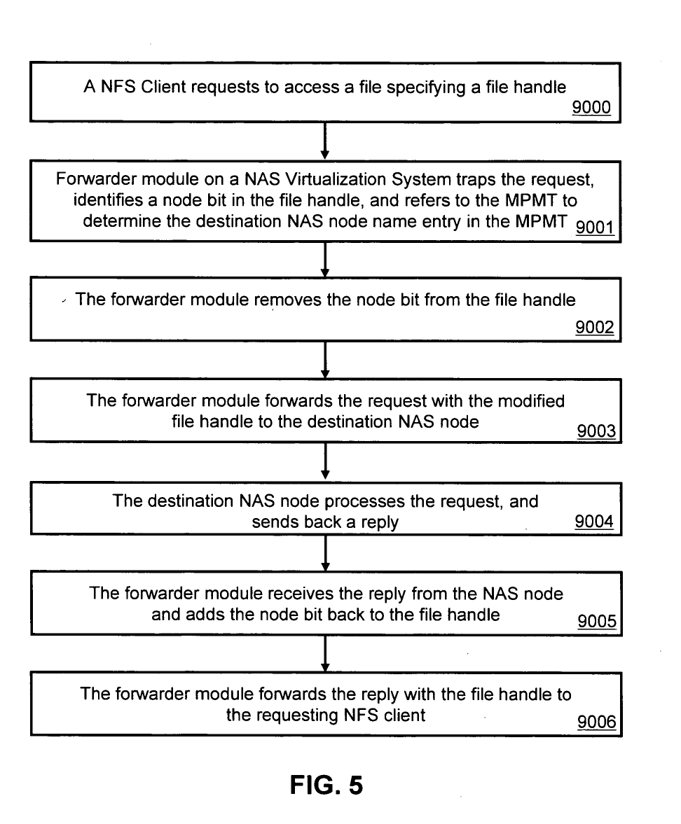

FIG. 5 illustrates a typical procedure for accessing a file such as by a read or write request for the file “/gnsroot/fs1/a.txt”. A description of the steps carried out in FIG. 5 is set forth below.

Step 9000: A NFS client 1012 requests to access a file specifying a file handle that the NFS client 1012 has already obtained by the procedure set forth in FIG. 4 and as discussed above.

Step 9001: Forwarder module 2122 on NAS virtualization system 2000 traps the request from the NFS client, identifies a node bit information of the file handle included in the request, and refers to the MPMT 2123 to determine the corresponding destination NAS node name.

Step 9002: Before forwarding the request to the corresponding NAS node, the forwarder module 2122 removes the node bit information from the file handle. This is necessary in some implementations of the invention, since the lower NAS systems 3000 would not necessarily recognize the node bit information attached to the file handle.

Step 9003: The forwarder module 2122 forwards the request with modified file handle to the corresponding destination NAS node. In the example set forth above, the request would be forwarded to NAS1 3000-1.

Step 9004: The destination NAS node processes the request and sends back a reply to NAS virtualization system 2000.

Step 9005: Forwarder module 2122 receives the reply from NAS1, and the forwarder module adds the node bit information back to the file handle. Alternatively, if the file handle has a reserved area, such as is sometimes the case that a file handle has an area reserved for vendors, and the NAS System 3000 can correctly ignore this area of the file handle, then the invention can use the reserved area for placement of the node bit information. For example, in some implementations, the lower NAS systems 3000 might ignore all but the last 32 bits of the file handle. In such a case, Steps 9002 and 9005 can be eliminated since it is not necessary to delete and then add back the node bit information to the file handle.

Step 9006: Forwarder module 2122 returns the reply including the file handle with appended node bit information to the requesting NFS client.

In other embodiments, as also illustrated by FIG. 3, the NAS virtualization system 2000 of the invention can be configured into an N-node cluster configuration, which means that the NFS clients 1012 can access to any one of “N” number of NAS virtualization systems 2000, each of which acts to virtualize the underlying NAS nodes 3000. In this case, any management tables such as MPMT 2123 would be synchronized among the NAS virtualization systems 2000 in the cluster. By allowing the cluster configuration, the NAS clients 1012 are able to balance the I/O work load over multiple NAS virtualization systems 2000.

File Level Migration

The GNS can integrate multiple file systems into one single name space. This enables migration to be done by the unit of entire file system, at a single file level, or anywhere in between (i.e., directory level). Thus, the invention provides for a method of file level migration that is non disruptive to a client. In this context, file level migration includes directory migration. As discussed above, several reasons for which file level migration might be desirable include data life cycle management or hierarchical storage management, in which cases fine-grained migration such as of individual files or directories, rather than an entire file system might be useful.

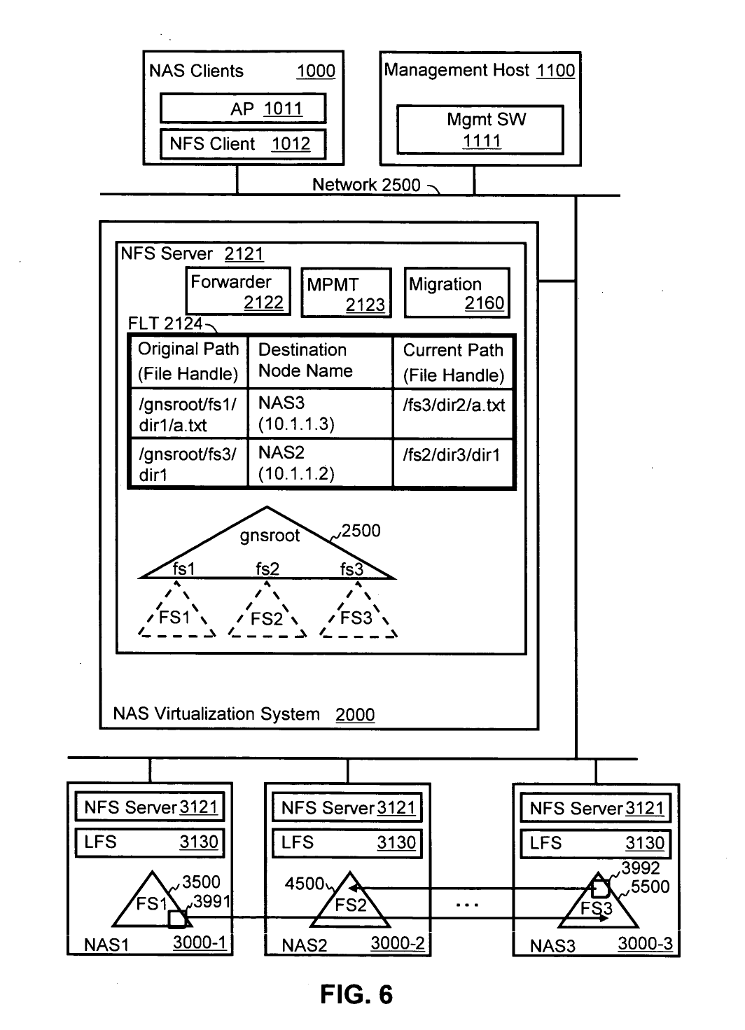

FIG. 6 represents a conceptual diagram of the file level migration mechanism. The system configurations are the same as described above with respect to FIG. 3. A GNS 2500 is constructed of FS1 3500 on NAS1 3000-1, FS2 4500 on NAS2 3000-2, and FS3 5500 on NAS3 3000-3. It will be assumed that the MPMT 2123 has already been configured for the GNS. Under this scenario, a file 3991 in FS1 such as “/gnsroot/fs1/dir1/a.txt” is migrated into FS3, and the path of file 3991 becomes “/fs3/dir2/a.txt” following the migration. As illustrated in FIG. 6, NAS virtualization system 2121 may include a migration engine 2160 for carrying out the migration, and file location table FLT 2124 is used for keeping track of the new file path.

To give an example, in some embodiments, in the case of hierarchical storage, NAS1 3000-1 might incorporate a first tier of performance in which the disk drives 3300 are of a first high performance type, such as FC drives, and FS1 exists on a volume that is allocated to the FC drives in NAS1 3000-1. On the other hand, NAS3 3000-3 might incorporate a lower tier level of performance in which the disk drives 3300 are of a lower cost, lower performance type, such as SATA drives, and FS3 exists on a volume that is allocated to the SATA drives. Then, an administrator would like to migrate unused files such as “/gnsroot/fs1/dir1/a.txt” to the lower cost SATA drives so that storage space on the higher performance, higher cost FC drives might be freed up. Thus, as illustrated in FIG. 6, first file or directory 3991 is migrated from FS1 to FS3 to free up storage capacity at FS1, while a second file or directory 3992 might be migrated from FS3 to FS2 for other purposes. The mechanism for accomplishing these migrations is described in additional detail below.

File Migration Phase

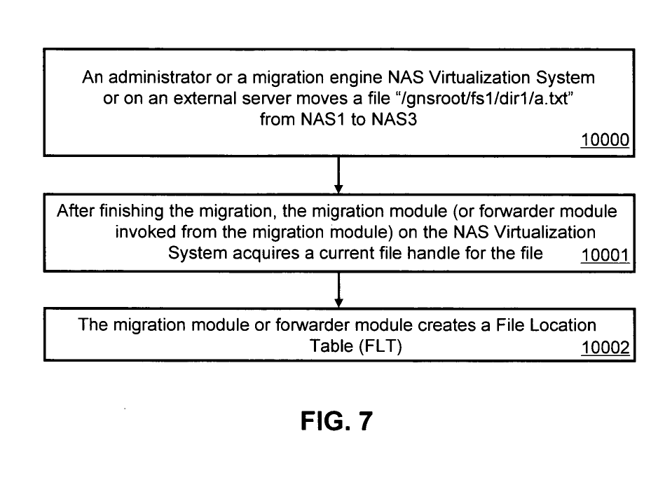

FIG. 7 illustrates a control flow for carrying out migration of a file or directory, the steps of which are described below.

Step 10000: An administrator or migration engine 2160 on NAS virtualization system 2000 or on an external computer moves first file 3991 “/gnsroot/fs1/dir1/a.txt” which is on NAS1 3000-1 as “/fs1/dir/a.txt” to NAS3 3000-3 as “/fs3/dir2/a.txt”. There are several options of handling access attempts to file 3991 during the migration process, three of which are set for below as options (a), (b) and (c).

(a) The NAS virtualization system 2000 can refuse any client access attempts to file 3991, such as by sending back an error message. In this case, the file access could be delayed for a long period of time, especially in the case of migrating a very large directory.

(b) The NAS virtualization system 2000 can move any particular file which has an access request first. This will minimize the access delay because access to the requested file will be available as soon as it is successfully migrated.

(c) The NAS virtualization system 2000 can cache the access request (in the case of a write), and then reflect the cached write data to the file after finishing the migration. As for the method of caching, NAS virtualization system 2000 can prepare memory or disk space in the NAS virtualization system 2000 to store the operations to the file. In this case, the changes made to the file during migration must not be lost or an inconsistency of data between NFS clients 1012 and NAS systems 2000, 3000 could occur. One method for caching is to utilize a file system provided by NAS virtualization system 2000 because the NAS virtualization system itself is a NAS System. The file may be migrated temporarily onto a file system in the NAS virtualization system 2000. Then, all changes made to the file during the migration can be performed on the copy of the file in NAS virtualization system 2000. After finishing the migration, the copy of the file in NAS virtualization system 2000 is copied to the migration destination on NAS system 3000.

Step 10001: After finishing the migration, the migration module 2160 (or forwarder module 2122 invoked from the migration module 2160) on the NAS virtualization system 2000 acquires a new file handle for the migrated file.

Step 10002: The migration module 2160 or forwarder module 2122 creates a file location table (FLT) 2124 on NAS virtualization system 2000. The typical entries of the FLT 2124 may include original file path and original file handle, destination node name, destination file path and current file handle.

File Access Phase Following Migration

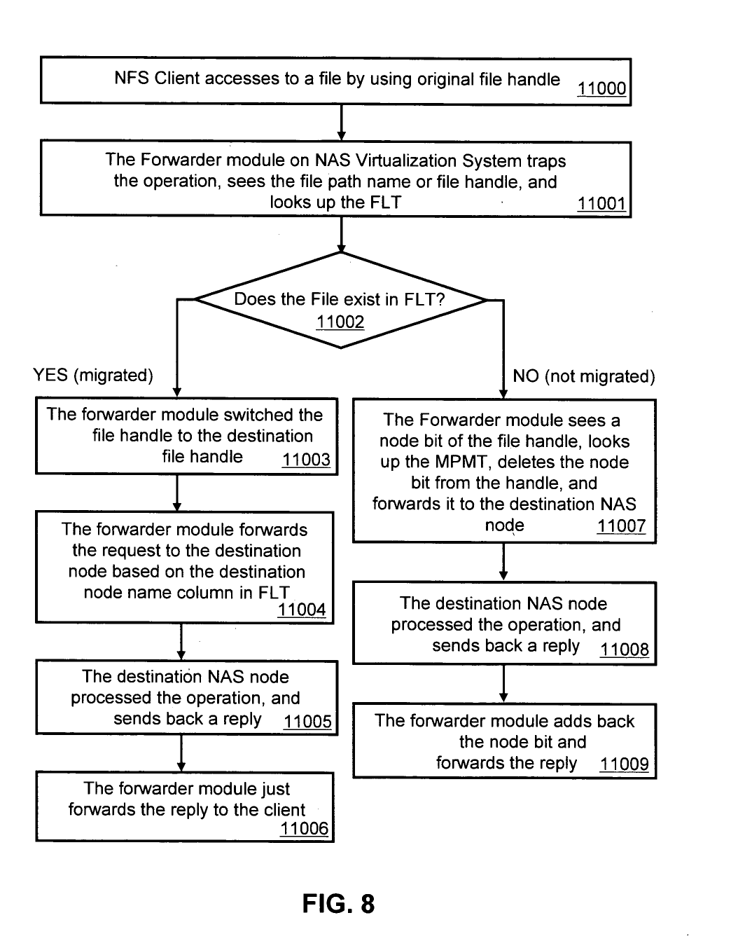

FIG. 8 illustrates a control flow of file access to the migrated file, as also described in the steps set forth below.

Step 11000: NFS client 1012 sends a request to access a file by using the original file handle because the client does not know of the migration of the file.

Step 11001: The forwarder module 2122 on NAS virtualization system 2000 traps the NFS operation from the NFS client, identifies the file path name or file handle, and refers to the FLT 2124 by looking for the file handle or path included with the request.

Step 11002: If the file exists in FLT 2124, then that means that the file has been migrated, and the process goes to Step 1103. If the file does not exist in the FLT 2124, then that means that no migration of the file has taken place and the process goes to step 1107 to carry out the process described in detail in FIG. 5.

Step 11003: If the file path name or file handle is in FLT 2124, this means that file migration has taken place for the requested file. Forwarder module 2122 determines from FLT 2124 the current file handle, and substitutes the current file handle in the request.

Step 11004: Forwarder module 2122 forwards the request with the current file handle to the destination NAS node based on the destination node name column set forth in FLT 2124.

Step 11005: The destination NAS node processes the operation and sends a reply back to the NAS virtualization system 2000.

Step 11006: When the destination NAS sends back a reply to the NAS virtualization system 2000, the forwarder module 2122 forwards the reply to the requesting NFS client using the original file handle and node bit information. This way, users do not have to change a file handle used for accessing a file every time the file is migrated.

Step 11007: If the file path name or file handle is not in FLT, which means that file migration has not happened, the forwarder module 2122 looks up MPMT 2123, and follows the same file access procedure as the GNS file access discussed above with respect to FIG. 5.

Step 11008: The destination NAS node processes the operation and sends back a reply, as described above with respect to FIG. 5.

Step 11009: The forwarder module adds the node bit information back the original file handle and returns the reply to the requesting NFS client, as described above with respect to FIG. 5.

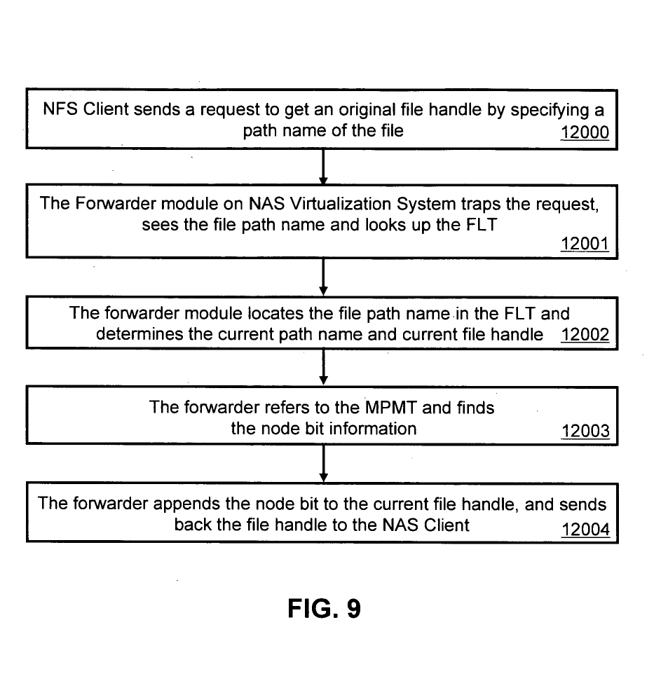

When file migration occurs before a particular NFS client 1012 accesses the file, then the particular NFS client typically will not have the file handle. However, in the case where migration has taken place, the forwarder will have obtained the file handle in order to be able to access the file for migration: In this case, the procedure is different from that set forth above in FIG. 4. FIG. 9 illustrates a process flow carried out in this situation.

Step 12000: NFS client 1012 sends a request to get an original file handle using the original path because the client does not know of the migration of the file.

Step 12001: The forwarder module 2122 on NAS virtualization system 2000 traps the operation, identifies the file path name, and refers to the FLT 2124.

Step 12002: Since the file has been migrated, the forwarder module 2122 locates the file path name in FLT 2124, and uses that to determine the current file handle and current path name for the file. (As discussed above, the current file handle is automatically obtained following migration.)

Step 12003: Forwarder module 2122 then refers to the MPMT 2123 using the current path name and locates the node bit information.

Step 12004: Forwarder module 2122 appends the node bit information to the current file handle, and sends back the file handle to the NAS client.

As an alternative to Steps 12002-12004 above, the original (i.e., before migration) file handle may be sent back to the requesting NFS Client instead of the current file handle. When this alternative option is performed, the history of the migration is preserved. Further, in the case where the current file handle is sent back as in Step 12004, there are multiple file handles on record for a single file, which may lead to confusion during file management. Accordingly, this alternative option avoids that, although slightly increasing overhead in the forwarder module 2122.

Thus, for managing file level migration, the NAS virtualization system maintains and manages the file locations. In addition to the file location, if the NAS virtualization system maintains and manages the file attributes of some or all files in the GNS, the NAS virtualization system 2000 can provide some additional functionalities on behalf of the underlying NAS systems 3000.

Attribute Management in NAS Virtualization System

The invention also provides for managing the file attributes of part or all of the files in the GNS in NAS Virtualization system 2000. To achieve this, the underlying NAS systems 3000 can be viewed merely as data storage, and the NAS virtualization system is able to provide some functionalities to files in the GNS, which means that NAS Virtualization system 2000 can virtualize the underlying NAS systems 3000. Moreover, response to the operations can be faster than without virtualization, because the operations do not have to be forwarded to the underlying NAS systems 3000. Initially, the method of managing the attributes is described. Some examples of functionalities that the NAS virtualization system can provide are then described after that.

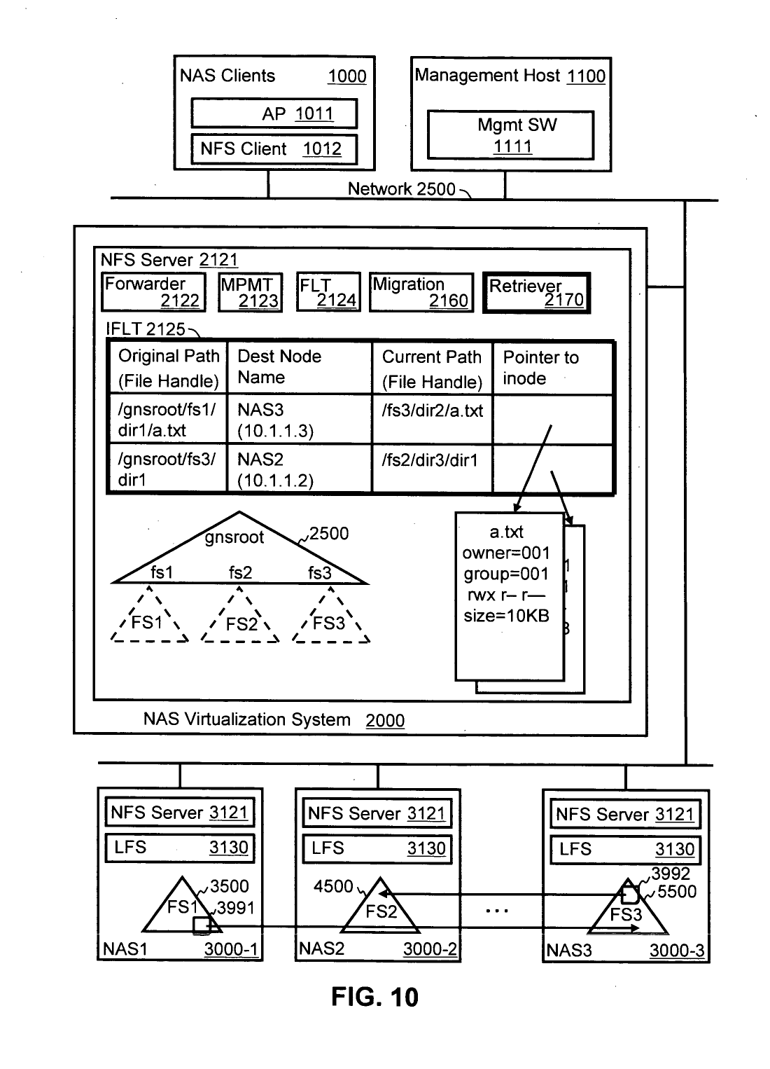

FIG. 10 represents a conceptual diagram of attribute management in NAS virtualization system 2000. To realize this, the NAS virtualization system maintains an alternate table, which is the inode and file location table (IFLT) 2125, in order to maintain file attributes. This may employ an extension of FLT 2124 into IFLT 2125 to enable NAS virtualization system 2000 to maintain attributes. However, the inode attribute information can be maintained by other means than file location table FLT 2124, such as with some association between FLT 2124 and attributes tables. In the illustrated embodiment, pointers to the attribute information are stored in IFLT 2125. Thus, the inode for the file is stored elsewhere in NAS virtualization system 2000, and retrieved when need using the stored pointer information. However, the attributes information itself can also be stored in the IFLT 2125 in other embodiments.

The attribute information that can be managed in NAS virtualization system 2000 includes inode information that can be retrieved by a normal NFS operation, such as GETATTR. Under the invention, when creating a new interface with file systems on the underlying NAS systems 3000, all inode information for the files on these systems can also be retrieved. As illustrated in FIG. 10, NAS virtualization system 2000 may include a retriever module 2170 for retrieving attribute information. The attributes may be retrieved by retrieving the inode for each file that includes attributes such as file name, owner, group, read/write/execute permissions, file size and the like. The entire inode may be stored in NAS virtualization system 2000, or merely certain specified attributes.

Retrieving File Attributes

There are several timings to invoke the file attribute retrieval from underlying NAS systems 3000 to NAS virtualization system 2000. Two typical cases include: (1) at some scheduled time (usually by directories or each file system); and (2) at the file migration (usually by each file).

In the first case, an administrator invokes retriever module 2170 or sets a schedule in retriever module 2170 to retrieve file attributes. After it is invoked, the retriever module 2170 reads inode information of each of the specified files, and stores the information into the IFLT 2125 on NAS virtualization system 2000. Once all attribute information for the files has been stored, all attribute accesses to the files can be processed by the NAS virtualization system 2000.

In the second case, an administrator or a migration module 2160 migrates a file (as described above with respect to FIGS. 6-9). After finishing the migration, the retriever module 2170 reads inode information of the file, and stores the information into the IFLT 2125 on NAS virtualization system 2000. Then, all attribute accesses to the file can be processed by the NAS virtualization system 2000.

File Access Phase Including Attribute Management

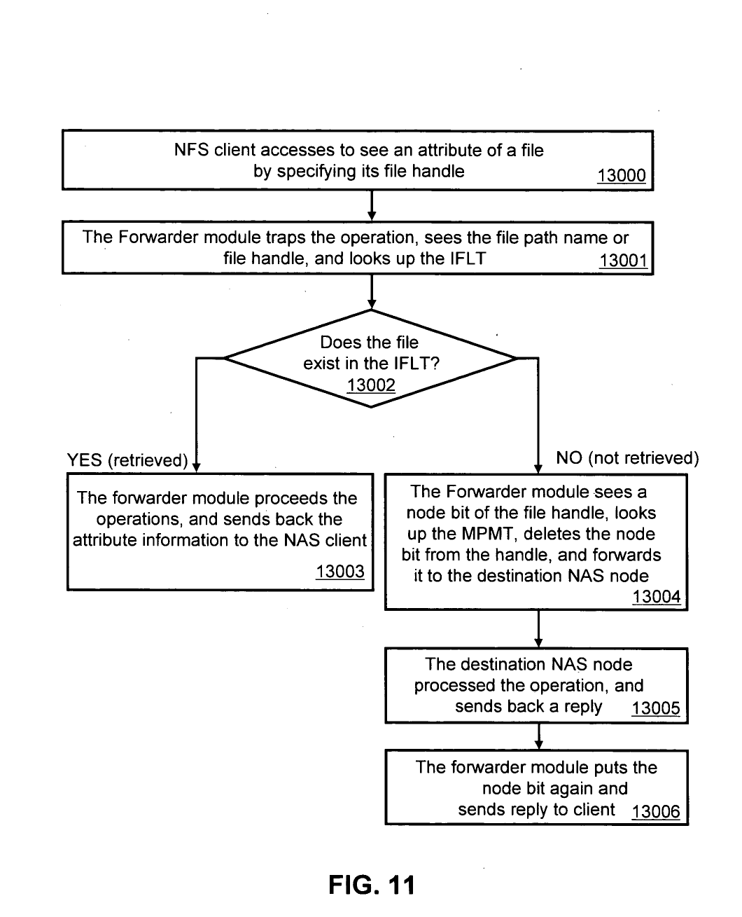

FIG. 11 illustrates a control flow of attribute accesses to a file having attributes managed by NAS virtualization system 2000.

Step 13000: NFS client 1012 send an access request to see an attribute of a file by specifying the file handle or file path name of the file.

Step 13001: The forwarder module 2122 traps the operation, identifies the file path name or file handle, and refers to the IFLT 2125.

Step 13002: The forwarder module 2122 determines if the file exists in the IFLT based upon the specified file handle of file path name.

Step 13003: If the file path name or file handle is in IFLT 2125, this means that the file attribute retrieval has occurred and/or that file migration has occurred. If file attribute retrieval has occurred, the forwarder module 2122 proceeds the requested operation, and sends back the requested attribute information to the NAS client.

Step 13004: If the file path or file handle is not in IFLT 2125, then file attribute retrieval has not occurred for the specified file. Thus, forwarder module 2122 must forward the request to the NAS system 3000 that maintains the file's attribute information. This is carried out in a manner similar to the process of FIG. 5. Accordingly, the forwarder refers to MPMT 2123, removes the node bit from the file handle, and forwards the attribute request to the destination NAS node.

Step 13005: The destination NAS node processes the request and sends back a reply with the attribute information.

Step 13006: The forwarder module 2122 adds the node bit information back to the file handle and sends the reply to the requesting client.

The foregoing sets forth a method whereby the NAS virtualization system 2000 is able to maintain and provide the attribute information for files in the GNS. In the following two sections, examples are provided that illustrate advantages of this implementation.

Account management and Access Control

User account management and access control may be handled in the NAS Virtualization layer. If all NAS clients have identical user account information, the NAS virtualization system 2000 needs to have the same account information, and is able to perform access control by using attribute information stored in IFLT 2125. When the NAS virtualization system 2000 accesses to underlying NAS nodes 3000, NAS virtualization system 2000 uses a special account. Thus, the underlying NAS nodes 3000 do not need to maintain user account information any more, and no longer need to perform access control for each user. This can result in a response of access control that in some cases is faster than the underlying NAS access control.

When the merger of departments or merger of companies takes place, there might be several different user accounts among NAS clients, and a solution for avoiding user account conflicts needs to be implemented in the system. There are several options to integrate user access information and manage access control in the NAS Virtualization layer 2000.

Under one option the underlying NAS nodes' user account information (e.g., usernames, passwords, etc.) can be integrated into one account information at NAS virtualization system 2000, and access control can then take place at NAS virtualization system 2000 with no need for client account information change. Further, there is no need to change the underlying NAS account information change and access controls because the NAS virtualization system 2000 will control access by clients, and the NAS virtualization system 2000 accesses the underlying NAS nodes 3000 by using a special account.

Under another option, all clients' account information may be changed so as to eliminate any conflicts. The changed account information may be installed at NAS virtualization system 2000, and access control will then be checked by NAS virtualization system 2000. This also eliminates the need of changing the underlying NAS nodes account information or access controls, since the NAS virtualization system 2000 accesses the underlying NAS nodes 3000 by using a special account.

A third option is to change user account information when the user's account is conflicted with other user's account at the NAS virtualization system 2000. NAS virtualization system 2000 maintains mapping information, and the new account information is registered in the underlying NAS nodes 3000. The underlying NAS nodes maintain management of user account information and access control, so that there is no need of client account information change. An integrated account management table (IAMT) 2126, as discussed further below, may be utilized in carrying out this option.

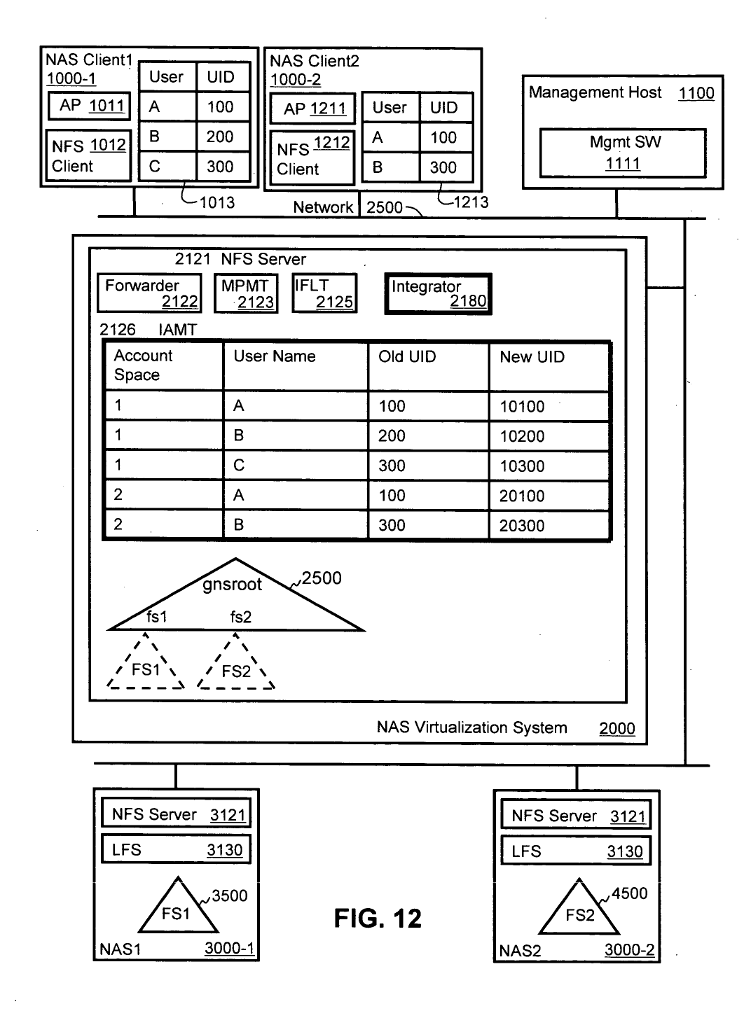

The example set forth below uses the first option because it realizes both no change at the client side and also allows NAS Virtualization layer access control. FIG. 12 represents a conceptual diagram of integrated account management and access control in NAS virtualization system. To realize this, the NAS virtualization system 2000 maintains integrated account management table (IAMT) 2126, for maintaining integrated user account information, and also includes an integrator module 2180 for integrating account information to create IAMT 2126.

The typical entries of IAMT 2126 include account space name, user name, old UID/GID (user ID/group ID), and new UID/GID. The account space name is an ID of user account type used in client side. Here NAS client1 1000-1 is in user account space 1, and NAS client2 1000-2 is in user account space 2. NAS client1 1000-1 and NAS client2 1000-2 have separate user account information such as 1013 and 1213, and FS1 3500 on NAS1 3000-1 is used by NAS client1, and is in user name space 1, while FS2 4500 on NAS2 3000-2 is used by NAS client2, and is in user name space 2. Thus, NAS1 has the same user account information as shown at information 1013, and NAS2 has the same user account information as shown at information 1213.

IAMT Creation Phase

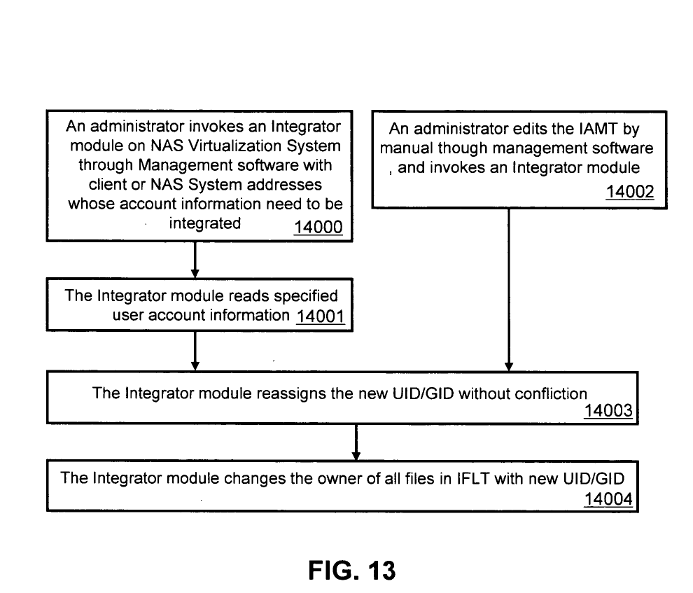

FIG. 13 illustrates a control flow of how IAMT 2126 may be created.

Step 14000: An administrator invokes integrator module 2180 on NAS virtualization system 2000 through management software 1111 using client or NAS System addresses whose account information need to be integrated.

Step 14001: The integrator module 2180 reads specified user account information, and integrates them into IAMT 2126 on NAS virtualization system 2000.

Step 14002: Alternatively to Steps 14000 and 14001, an administrator may edit the IAMT 2126 manually through management software on management host 1100.

Step 14003: The integrator module 2180 reassigns the new UID/GID without conflicts.

Step 14004: The integrator module changes the owner of all files in IFLT with the new UID/GID. Since the access to the underlying NAS systems 3000 is done by the special account of NAS virtualization system 2000, there is no need to carry out owner change in the underlying NAS systems 3000. Further, if it ever becomes necessary to go back to the original environment, which means detaching the user name space from the GNS, there is no need of reassignment of owner in the detached NAS System 3000.

When a user account on a NAS client 1000 is modified, added, or deleted, the IAMT 2126 needs to be changed as well.

User account modification: An administrator edits the account entry which is modified at the client side through management software.

User account addition: An administrator adds the account entry, which is added at the client side through management software, and invokes the integrator module 2180 in order to assign a new UID/GID.

User account deletion: An administrator deletes the account entry which is deleted at the client side through management software.

The above are based on the administrator's manual operation. If an agent module is installed on the NAS client side, it is possible to notify the account change at the client side to integrator module 2180. Then, the integrator module 2180 is able to update the information as described above automatically without requiring administrator intervention.

File Access Phase

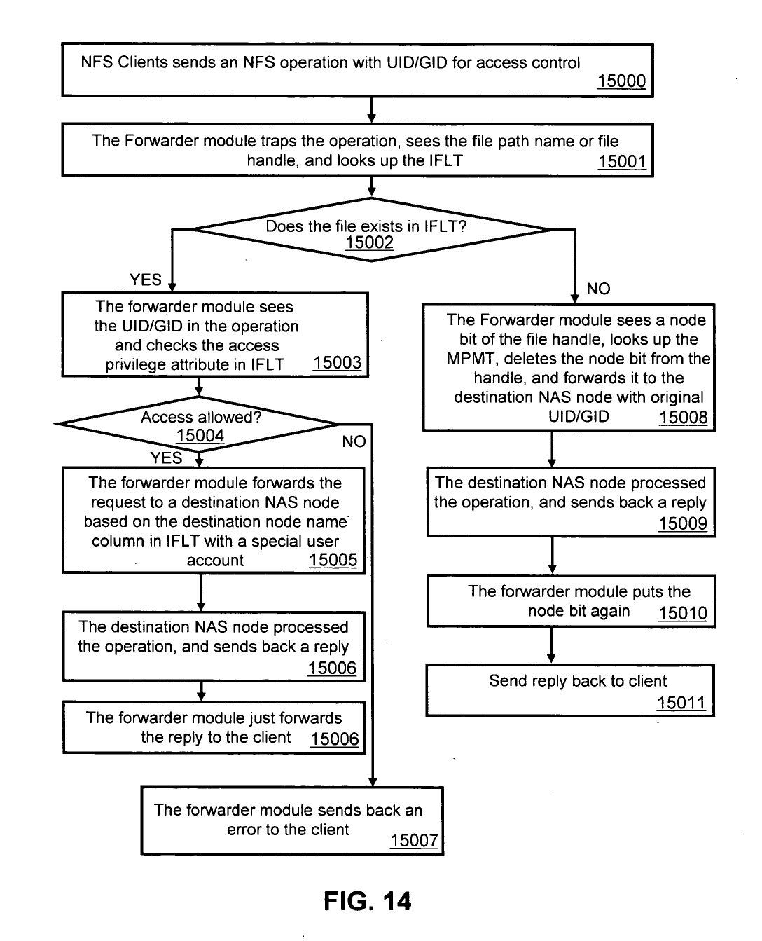

FIG. 14 illustrates a control flow of file access which is controlled by NAS virtualization system 2000 in the above-described example.

Step 15000: NFS client 1012 sends an NFS operation with UID/GID for access control.

Step 15001: The forwarder module 2122 traps the operation, sees the file path name or file handle, and looks up the IFLT 2125. When the access control is done by the NAS virtualization system 200, attribute information of all files should be managed in IFLT 2125.

Step 15002: The forwarder module 2122 determines whether the file exists in IFLT 2125.

Step 15003: If the file path name or file handle is in IFLT 2125, the forwarder module 2122 locates the UID/GID in the operation and checks the access privilege attribute contained in IFLT 2125 for the file.

Step 15004: Forwarder module determines whether the requesting client has access privileges according the checked attribute.

Step 15005: If the access is allowed, the forwarder module forwards the request to the destination NAS node 3000 based on the destination node name column in IFLT 2125. The NAS virtualization system is able to access the NAS node 3000 with a special user account so that an additional check of the requesting client's access rights is not checked by destination NAS node 3000.

Step 15006: When the destination NAS node sends back a reply to the client, the forwarder module forwards the reply to the client.

Step 15007: If the client's access request is denied at step 15004, the forwarder module 2122 sends back an error to the client.

Step 15008: If the file path name or file handle is not in IFLT (this will happens only when attribute information of partial files are stored in IFLT or when an error occurs), the forwarder module 2122 refers to MPMT, and follows the same file access procedure as the GNS file access process discussed above with respect to FIG. 5, and includes the original UID/GID with the request to the destination NAS node.

Step 15009: The destination NAS node 3000 checks the access privileges of the requesting client, and sends back a reply if the access is allowed, or sends back an error if access is denied.

Step 15010: The forwarder module adds the node bit information to the reply.

Step 15011: The forwarder module sends the reply to the requesting client.

Quota Management

A second example application of attribute management by NAS virtualization system 2000 is quota management. Before the invention, quota management of storage capacity allotted to a user has been performed by the underlying NAS systems at the unit of a file system. In the invention, the NAS virtualization layer can manage the quota over the GNS, which means the quota management is able to cover all file systems in the GNS. In addition to quota management, the NAS virtualization system can invoke the migration of files based on the usage of quotas, and even if the migration takes place, the quota management is continued.

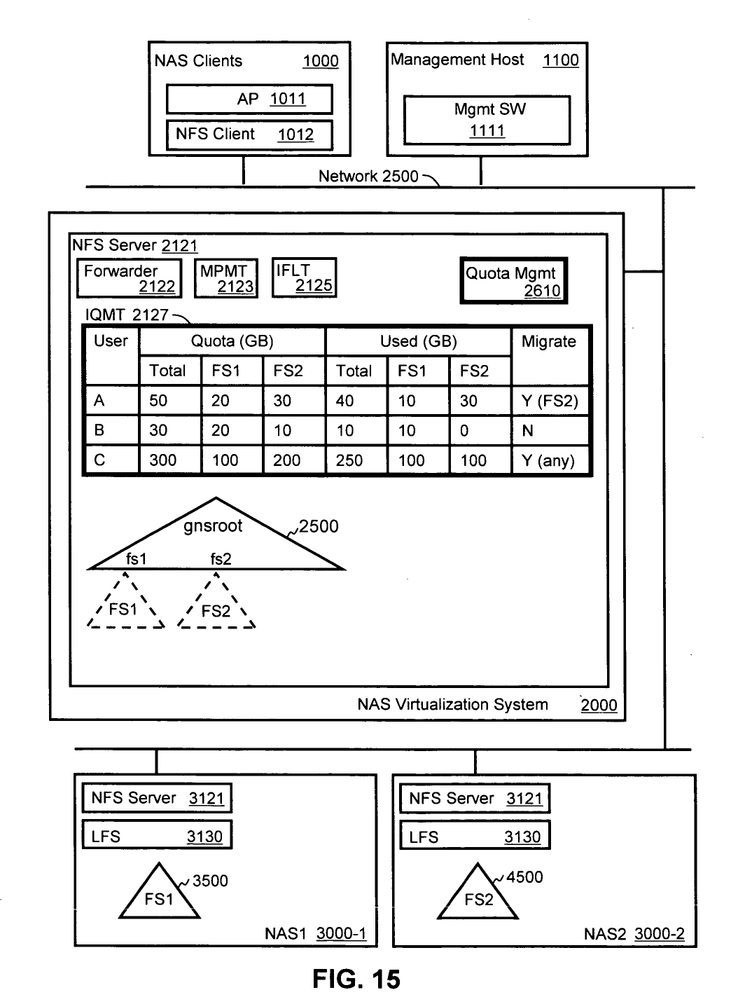

FIG. 15 represents a conceptual diagram of quota management in NAS virtualization system 2000. To realize this, the NAS virtualization system maintains another table, which is Integrated quota management Table (IQMT) 2127, for maintaining integrated quota information. A quota management module 2610 may also be included in NAS virtualization system 2000. The NAS virtualization system retrieves quota information such as limit and used capacity from the underlying NAS systems by using read operations to a quota related file. However, if quota management is not already active, then the NAS virtualization system does not have to retrieve the quota management information from the underlying NAS systems, such as in the case where an administrator sets the quotas at the NAS virtualization system as the initial quota settings and there is no quota settings for the underlying NAS systems.

The typical entries of IQMT 2127 are user name, quota limit, used capacity, and migration allowance bit. The quota limit may be managed for each separate file system and/or according to a total limit. The used capacity may also be managed for each file system, and/or total used capacity. If the migration acceptance bit is on (“Y”), a file which is created to exceed the quota limit or some threshold in a file system can be migrated to another file system other than the intended file system to maintain the user from exceeding the total quota. The destination file system in the event of such a migration is predetermined by an administrator, and stored in IQMT 2127, or determined by the quota management module 2610 according to some policy, such as a least used file system. If the migration acceptance bit is off (“N”), a file which is created to exceed the quota limit cannot be created and the NAS virtualization system 2000 sends back an error to the requesting NAS client 1000.

IQMT Creation Phase

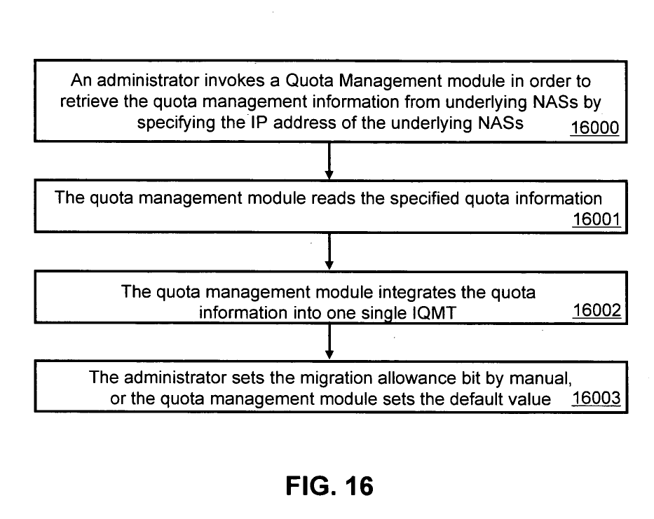

FIG. 16 illustrates a control flow of quota setting for creating the IQMT 2127.

Step 16000: At GNS creation or at some time after the GNS creation, an administrator invokes quota management module 2610 in order to retrieve the quota management information from underlying NAS nodes by specifying the IP address of the underlying NAS nodes.

Step 16001: The quota management module 2610 reads the specified quota information.

Step 16002: The quota management module 2610 integrates the collected quota information into one single IQMT 2127 on NAS virtualization system 2000.

Step 16003: An administrator sets the migration allowance bit manually, or the quota management module 2610 sets a default value.

File Access Phase

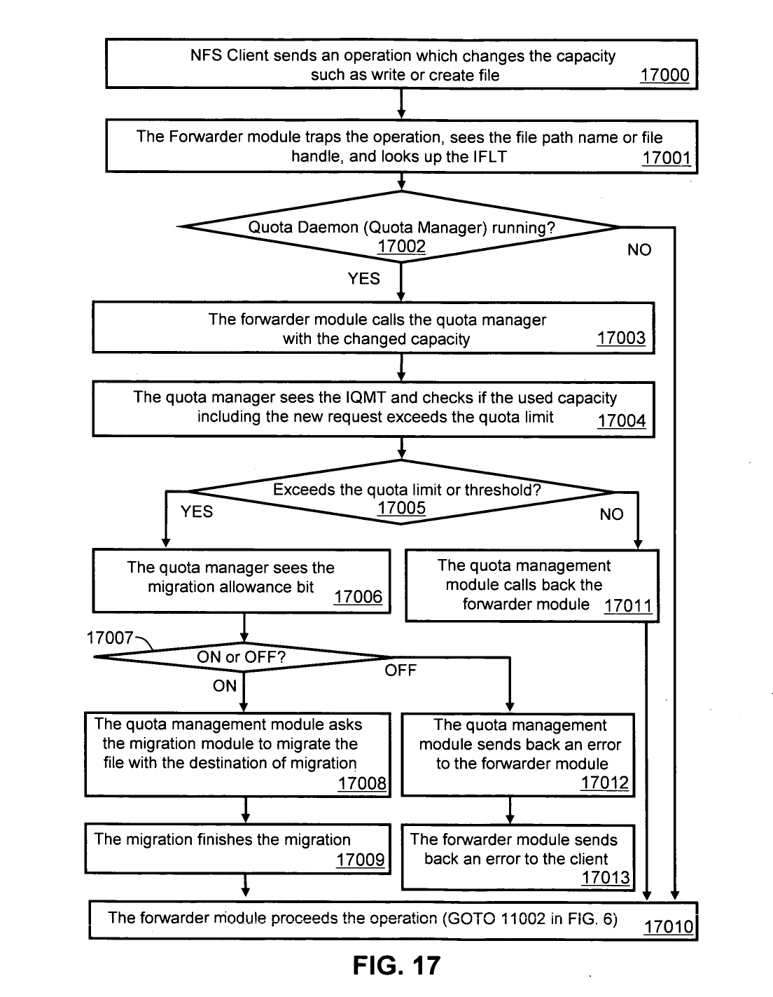

FIG. 17 illustrates a control flow of file access with the above-described quota management in effect on NAS virtualization system 2000.

Step 17000: NFS client 1012 sends an operation to NAS virtualization system 2000 that changes the capacity of the client's storage, such as in a write command or a create file command.

Step 17001: The forwarder module 2122 traps the operation, identifies the file path name or file handle, and looks up the file in the IFLT 2125.

Step 17002: The forwarder determines whether quota manager 2610 is running. The quota manager 2610 may run as a daemon in the background to monitor quota usage. If the quota manager is not running, the process goes to Step 17010.

Step 17003: If the quota daemon (quota manager 2610) is running, the forwarder module calls the quota manager with the changed capacity.

Step 17004: The quota manager refers to the IQMT 2127 for the requesting client's quota information.

Step 17005: The quota manager determine whether the used capacity including the new request will exceed the quota limit for the user.

Step 17011: If the used capacity is less than the quota limit, the quota management module 2610 calls back the forwarder module, and the process goes to Step 17010.

Step 17006: If the used capacity exceeds the quota limit or a threshold determined by an administrator, the quota manager checks the migration allowance bit for the requesting user.

Step 17007: The quota management module 2610 determines if the migration allowance bit is off or on.

Step 17008: If the migration bit is on, the quota management module 2610 asks the migration module 2160 to migrate the file to the specified destination of migration.

Step 17009: When the migration module finishes migration, the process goes to Step 17010.

Step 17012: If the migration bit is off, the quota management module 2160 sends back an error to the forwarder module 2122.

Step 17013: The forwarder module then sends back an error to the client because the client's quota would be exceeded.

Step 17010: The forwarder module proceeds with completing the requested operation.

Every capacity change operation may be monitored by quota management module 2610. Accordingly, even if a migration happens that is not because of quota management, the capacity changed can be registered into IQMT 2127.

Thus, it may be seen that the invention provides a means for client computers to reduce the number of mount points to a single GNS, and a means for virtualizing functions of multiple NAS systems into a single NAS access point. Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of operating an information system, comprising:
providing multiple network attached storage (NAS) systems, each said NAS system including a NAS head able to store file data to a storage system, each said storage system including storage devices for storing the file data, each said NAS system including a local file system for providing access to files stored on said storage systems, said NAS systems able to communicate with each other via a network, said NAS systems including a first NAS system and one or more second NAS systems;
receiving, by the first NAS system, a file access operation sent from a computer via said network and directed to one of said second NAS systems;
locating a file identifier included in the file access operation, said file identifier including node information identifying the one second NAS system as a destination of the file access operation; and
forwarding the file access operation from the first NAS system to the second NAS system identified by the node information.

2. A method according to claim 1, further including a step of
removing said node information from the file identifier prior to forwarding the file access operation with the file identifier to the one second NAS system.

3. A method according to claim 2, further including steps of
receiving at the first NAS system a response from the second NAS system in response to the file access operation;
adding the node information back to the file identifier included with said response; and
forwarding the response to the computer with the file identifier having said node information attached.

4. A method according to claim 1, further including steps of
receiving at the first NAS system a request from the computer for a file handle of a file;
referring to a table by said first NAS system for identifying one of said second NAS systems having a file system including the file;
forwarding the request by the first NAS system to the identified second NAS system;
receiving the file handle from the identified second NAS system;
adding node information to the file handle, said node information identifying the identified second NAS system; and
forwarding the file handle with added node information to said computer.

5. A method according to claim 1, further including steps of
migrating a file from an original second NAS system having a first local file system to a destination second NAS system having a second local file system; and
receiving by said first NAS system a current file identifier for the file from the destination second NAS system.

6. A method according to claim 5, further including steps of
receiving at the first NAS system from the destination second NAS system an inode for the file;
storing the inode in said first NAS system;
receiving at the first NAS system from the computer a request for attribute information for said file; and
retrieving the attribute information stored in the first NAS system for the file and returning the requested attribute information to the computer.

7. A method according to claim 1, further including a step of
presenting, by the first NAS system, a global name space to a user of the computer, said global name space comprising an integration of at least part of one or more of said local file systems on one or more of said second NAS systems, whereby the first NAS system provides functionalities to files in the global name space, such that the first NAS system virtualizes the one or more second NAS systems.

8. A method for migrating a file, comprising:
providing multiple network attached storage (NAS) systems, each said NAS system including a NAS head able to store file data to a storage system, each said storage system including storage devices for storing the file data, each said NAS including a local file system for providing access to files stored on said storage systems, said NAS systems able to communicate with each other via a network, said NAS systems including a first NAS system and multiple second NAS systems;
storing an original identifier of a file in the first storage system;
migrating the file from an original second NAS system to a destination second NAS system;
storing a current identifier of the file in the first NAS system;
receiving, by the first NAS system, a file access operation sent from a computer via said network and directed to the file using the original identifier;
determining by the first NAS system that the file has been migrated and retrieving the current file identifier; and
forwarding the file access operation to the destination second node with the current file identifier.

9. A method according to claim 8, further including steps of receiving at the first NAS system a response from the destination second NAS system in response to the file access operation;
removing the current file identifier from the response; and
forwarding the response to the computer with the original file identifier.

10. A method according to claim 8, further including steps of
receiving at the first NAS system a request from the computer for a file handle of the file;
determining by said first NAS system the current file handle for the file by referring to the current identifier stored in the first NAS system;
adding node information to the current file handle, said node information identifying the destination second NAS system; and
returning the current file handle with added node information to said computer.

11. A method according to claim 8, further including steps of during migration of the file, migrating a copy of the file onto the first NAS system;
continuing to conduct read and write operations to the file during migration by conducting read and write operations to the copy of the file on the first NAS system; and
copying the copy of the file to the destination second NAS system to replace the migrated file after finishing the migration.

12. A method according to claim 8, further including steps of
receiving at the first NAS system from the destination second NAS system an inode for the file;
storing the inode in said first NAS system;
receiving at the first NAS system from the computer a request for attribute information for said file; and
retrieving the attribute information stored in the first NAS system for the file and returning the requested attribute information to the computer.

13. A method according to claim 8, further including a step of
presenting, by the first NAS system, a global name space to a user of the computer, said global name space comprising an integration of at least part of said local file systems on said second NAS systems, whereby the first NAS system provides functionalities to files in the global name space, such that the first NAS system virtualizes the second NAS systems.

14. A method according to claim 8, further including steps of
receiving write data for the file by the first NAS system during migration; and
caching the write data by the first NAS system, and then reflecting the cached write data to the file after finishing the migration, wherein the first NAS system prepares memory or disk space in the first NAS system to store the write data by utilizing a file system provided by the first NAS system.

15. A method of operating an information system, comprising:
providing multiple network attached storage (NAS) systems, each said NAS system including a NAS head able to store file data to a storage system, each said storage system including storage devices for storing the file data, each said NAS including a local file system for providing access to files stored on said storage systems, said NAS systems able to communicate with each other via a network, said NAS systems including a first NAS system and one or more second NAS systems;
receiving, by the first NAS system, a file access operation sent from a computer via said network and directed to one of said second NAS systems;
locating, by the first NAS system, a file identifier included in the file access operation, and retrieving attribute information stored in the first NAS system that corresponds to said file access information; and
returning a response to said computer from the first NAS system based on said retrieved attribute information.

16. A method according to claim 15, further including a step of
determining that said file access operation is an attempt to access a file on one of said second NAS systems;
determining from said retrieved attribute information whether said computer is authorized to access said file on said one of said second NAS systems;
forwarding said file access operation to said one of said second NAS systems when the attribute information shows that the computer is authorized to access the file; and
returning an error to the computer when the computer is not authorized to access the file.

17. A method according to claim 15, further including steps of
determining that said file access operation is an attempt to write to a file or create a file on one of said second NAS systems;
determining from said retrieved attribute information whether said computer has sufficient storage quota to write to the file or create the file on one of said second NAS systems;
forwarding said file access operation to said one of said second NAS systems when the attribute information shows that the computer has sufficient storage quota; and
returning an error to the computer when the computer does not have sufficient storage quota.

18. A method according to claim 15, further including steps of
migrating a file from an original second NAS system having a first local file system to a destination second NAS system having a second local file system; and
receiving by said first NAS system a current file identifier for the file from the destination second NAS system and attribute information for said file.

19. A method according to claim 18, further including steps of
receiving at the first NAS system from the destination second NAS system an inode for the file; and
storing the inode in said first NAS system as the attribute information.

20. A method according to claim 15, further including steps of
receiving at the first NAS system from the second NAS systems inode information for files in said second NAS systems, and storing the inode information in said first NAS system as the attribute information prior to said step of receiving the file access operation sent from the computer.

21. A method according to claim 15, further including a step of
presenting, by the first NAS system, a global name space to a user of the computer, said global name space comprising an integration of at least part of one or more of said local file systems on one or more of said second NAS systems, whereby the first NAS system provides functionalities to files in the global name space, such that the first NAS system virtualizes the one or more second NAS systems.
